(19) United States
(12) Patent Application Publication
(10) Pub. No.: US 2007/0250540 A1
(43) Pub. Date: Oct. 25, 2007

(54) A Computer System with File Attribute Extension

(76) Inventor: Mike Sheng Con Hsu, San Jose, CA (US)

Correspondence Address: CHEIN-HWA S. TSAO, 6684 MT PAKRON DRIVE, SAN JOSE, CA, 95120, US

(21) Appl. No.: 11/379,415

(22) Filed: Apr. 20, 2006

(51) Int. Cl. G06F 17/30

(52) U.S. Cl. 707/200

(57) ABSTRACT

A computer OS with an extended file attribute (EFA) is proposed to extend, without modifying a legacy virtual file system, the legacy file attribute of legacy files where each legacy file includes a file content and a legacy file attribute. The OS has a file attribute extension mechanism for adding EFA to the legacy file attribute. The file attribute extension mechanism includes: a) During EFA creation, adding EFA to legacy file attribute by concatenating an encoded file content extension to the file content. b) During EFA access, decoding the encoded file content extension and accessing the EFA. Also included is an Application Programming Interface (API) mechanism for generating system call to access each file. In turn, the system call firstly calls the legacy virtual file system to access each file plus legacy file attribute and concatenated encoded file content extension, and secondly accesses EFA via the file attribute extension mechanism.

### BACKGROUND OF THE INVENTION

1. Field of the Invention

The present invention relates generally to the field of computer Operating System (OS). More specifically it relates to the file management function of an OS.

2. Description of the Related Art

In many modern computer systems, especially those with an OS supporting multiple simultaneous users, the file content of each computer file created and managed through the Kernel of the OS has, in addition to a data content component, an associated file attribute component that is user-specific. The content of each file attribute, inter alia, is used to inform the OS certain rules and constraints for handling the associated computer file. As an example, the file attribute of a computer file created under the UNIX™ OS functions to control the right of user access of the subject computer file for reading and/or writing purposes. Thus, in general, a user-B should not have the right to access, for writing purpose, a computer file created by a user-A and vice versa. However, a super user, such as the system administrator, might as a policy be given an unlimited right to access, meaning for reading and writing, any computer file regardless of its authorship. As a second example, another file attribute of the computer file can be created to signify the computer or natural language base for encoding its data content, etc. Simply stated in a functional form, each file of the numerous user's computer files under the OS management looks like:
file=file attribute+file content (1)
where the file attribute (FA) is typically a qualitative, universally defined and managed parameter set signifying, for example, the right to access the subject file itself, the natural language base for encoding the FC, etc. Whereas the file content (FC) is a user-specific content portion of the subject file, for example a text file that is a program source code in the C programming language, or a JPEG file representing an image, etc. While both FA and FC are accessible through a pre-assigned file address for the subject file, it is remarked that, in general, FA and FC are not necessarily stored next to each other in memory.

As the sophistication and functional flexibility of the computer continue to advance with the simultaneous, explosive growth of Internet applications, the demand for FA with increased complexity and sophistication also arises. For example, in the environment of a networked corporate computer system with further transaction with the outside world through the Internet, the simple concept of user right to access computer files for reading and/or writing may need to be embodied with sophisticated policy dealing with the corporate departmental management structure, the multi-generational authorship of documents and the outside Internet access of documents with its associated security concern, etc. Therefore, in time the capacity and sophistication of a legacy FA managed by a legacy OS can become inadequate and need to be extended with OS modification into a new OS. The new OS should work with both legacy computer files and new files with extended file attribute (EFA) to effect the transition. For the same reason, it is also desirable to minimize/avoid the amount of modification of the legacy OS and all its associated numerous legacy applications. Thus, it is highly important that the numerous legacy applications do not need to be modified at all. A second important example of the legacy OS are its legacy file systems (FS) that, through years of cumulated development history, are often out of reach or too complex to modify. Hence, there is a need of extending the existing legacy FA into an EFA without modifying either the legacy applications or the legacy FS. Satisfying this need would also make the EFA automatically available to all future applications and FS as well.

### Glossary

EFA extended file attribute
FA file attribute
FC file content
FS file system
JPEG Joint Photographic Expert's Group
VFS virtual file system

### SUMMARY OF INVENTION

To effect the EFA as describe above, the present invention Proposes to support the EFA functionality at a kernel layer, within the OS, above and independent of the actual legacy FS. Therefore, all the resulting features and benefits of the EFA would be readily available to the various specific file management systems under the FS.

A new computer OS with an EFA function is proposed to extend, without modifying an existing legacy virtual file system, the legacy file attribute of numerous legacy files accessed under the management of the legacy virtual file system where each legacy file includes a file content and a legacy file attribute of legacy attribute size. The new OS, besides supporting numerous application programs, has a file attribute extension mechanism for adding desired EFA to the legacy file attribute. The file attribute extension mechanism further includes:
1) during creation of the EFA, adding the EFA to the legacy file attribute by concatenating an encoded file content extension, embedding the EFA, to the file content.
2) during access of the EFA, accessing, decoding the encoded file content extension and accessing the decoded EFA.
   The new OS also includes an Application Programming Interface (API) mechanism, invokable by the numerous application programs, for generating a system call to access each file with the EFA. The system call in turn is embodied for firstly calling the legacy virtual file system thus accessing each file together with its legacy file attribute and the concatenated encoded file content extension, and secondly accessing the EFA via the file attribute extension mechanism.

The system call includes a file attribute management mechanism for managing the EFA of the numerous legacy files and, based upon the content of the EFA, for generating the corresponding call to the legacy virtual file system.

In one embodiment, the encoded file content extension includes allowable EFA from a pre-defined validity set. Correspondingly, the decoding process of the encoded file content extension checks the accessed EFA against this validity set. This facilitates discrimination between files created with the EFA function and legacy files created absent the EFA function thus reducing the probability of accessing a false EFA.

In another embodiment, the encoded file content extension includes a delineation of the embedded EFA with a pre-defined set of delineation data patterns. Correspondingly, the decoding process of the encoded file content extension checks for the existence of valid delineation data patterns. This facilitates discrimination between files created with the EFA function and legacy files created absent the EFA function thus reducing the probability of accessing a false EFA. A further refinement of this embodiment is to have the delineation data patterns include a pre-defined leading signature pattern preceding the EFA and a pre-defined trailing signature pattern following the EFA. Yet another refinement is to have the leading signature pattern and/or the trailing signature pattern made up of a predefined number of signature bytes.

In another embodiment, the EFA can be made up of a specifiable number of extended file attribute bytes. A refinement is to have the pre-defined set of delineation data patterns include the specifiable number such that it follows the leading signature pattern.

In yet another embodiment, the invocation of the API mechanism can be made syntactically identical to the invocation of a corresponding legacy API function of a legacy OS without the EFA function thus facilitating a backward compatibility with the legacy OS at the application programming level.

A number of specific application examples of EFA, to be presently illustrated, includes file encryption key delegation and forced file encryption.

To the accomplishment of the above and related objects, this invention may be embodied in the form illustrated in the accompanying drawings, attention being called to the fact, however, that the drawings are illustrative only, and that changes may be made in the specific construction illustrated.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a simplified software architectural diagram of a computer system within which the present invention resides;

FIG. 2 is the simplified flow chart of a file-accessing process that reads a file within the computer system;

FIG. 3 is a simplified illustration of a file-accessing process that employs the fundamental mechanism of the present invention to read a file with extended file attribute within the computer system; and

FIG. 4 is an example of a simplified data structure illustrating the concatenation of an encoded file content extension to the file content under the present invention.

### DETAILED DESCRIPTION OF THE PREFERRED EMBODIMENTS

In the following detailed description of the present invention, numerous specific details are set forth in order to provide a thorough understanding of the present invention. However, it will become obvious to those skilled in the art that the present invention may be practiced without these specific details. In other instances, well known methods, procedures, components, and hardwares have not been described in detail to avoid unnecessary obscuring aspects of the present invention. The detailed description is presented largely in terms of logic blocks and other symbolic representations that directly or indirectly resemble the related software operations. These descriptions and representations are the means used by those experienced or skilled in the art to concisely and most effectively convey the substance of their work to others skilled in the art.

Reference herein to “one embodiment” or an “embodiment” means that a particular feature, structure, or characteristics described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations of the invention.

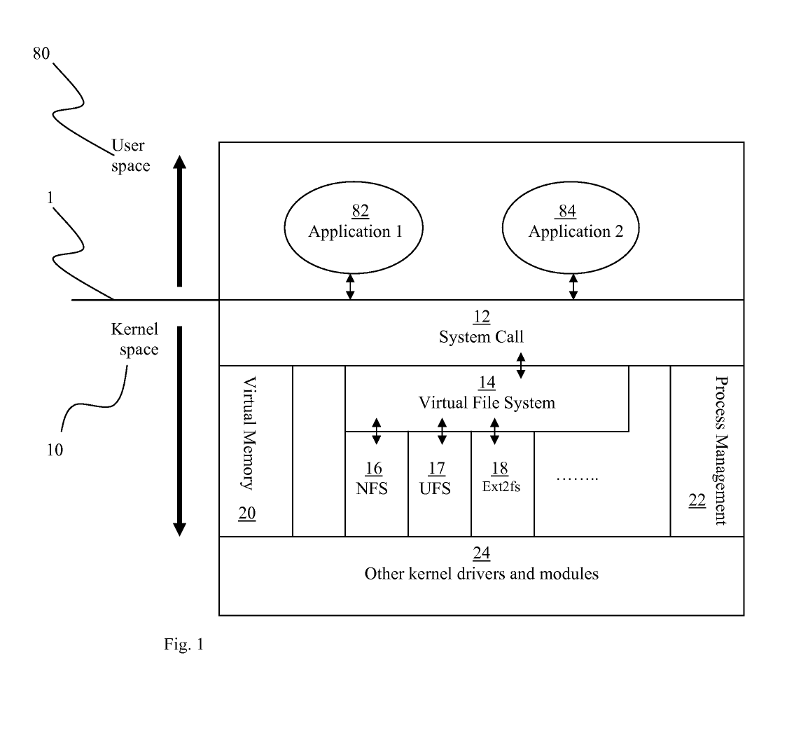

For simplicity of illustration, the new computer OS of the present invention is described under the UNIX™ Operating System. Note that in this application, the term UNIX™ refers to a broad arrange of UNIX™ flavored OS including but not limited to Solaris of Sun Microsystems, AIX of IBM Corporation, HP-UX of Hewlett Packard, the popular Linux OS and BSD. The Microsoft Windows™ OS, although not a UNIX™ flavor, also in many ways resembles and shares common characteristics and attributes with the UNIX™ OS. Hence, within the scope of the present invention the terminology ‘modern operating systems’ is used to collectively address all popular commercial and open source OS. FIG. 1 is a simplified software architectural diagram of a modern operating system within which the present invention resides. As illustrated, the internals of a modern OS kernel is conceptually divided into various layers and modules within the computer memory. Above a Dividing Line 1 is a User Space 80 where numerous application programs reside and run, such as application-1 82 and application-2 84, etc. Below the Dividing Line 1 is a Kernel Space 10 where the OS resides and runs. Within the top of the Kernel Space 10 is a layer named System Call 12, located right beneath the Dividing Line 1, that interfaces with the user applications 82 and 84. While not specifically shown here, the OS also includes a set of Application Programming Interface (API) functions, each of them invokable by the execution of instructions of application programs like 82 and 84, for generating a system call to the System Call 12 to access computer files or to perform other OS-level functions. A layer named Virtual File System (VFS) 14, lying below the System Call 12 and interfacing therewith, serves as a common interface between the System Call 12 and a plurality of selectable physical file system modules, such as the illustrated NFS 16, UFS 17, Ext2fs 18, etc. In operation, the Virtual File System 14 would receive a call from the System Call 12 and effect a corresponding read or write operation accessing an addressed computer file stored under any of the illustrated existing file systems NFS 16, UFS 17, Ext2fs 18. Therefore, collectively the illustrated NFS 16, UFS 17, Ext2fs 18, etc. functions as a file storage subsystem for storing numerous computer files each accessible through its pre-assigned file address and, by history of development, each computer file further includes a file content and a limited legacy file attribute of legacy attribute size. Examples of the file content can be a text string representing the source code of a computer program file, an image file encoded in a Joint Photographic Expert's Group (JPEG) format, etc. An example of the legacy file attribute can be a single byte signifying the accessibility of the file content regarding performing a read or write operation thereto. It should be clear to those skilled in the art that there is at least one processor, including programming, for executing instructions implementing the OS and the user applications 82 and 84. The processor(s) is also coupled to the computer memory and the file storage subsystem to permit data transfer there between. By history of development, additional examples of existing legacy file systems in use include AFS (Andrew FS), EXT2, EXT3, REISER, JFS, JFS2, NTFS, MSDOS-FS, ISOFS, CDROMFS, CACHEFS, NAMEFS, HPFS, CODAFS, ADFS and SMBFS. A few other illustrated functional modules of the OS Kernel Space 10 include Virtual Memory 20, Process Management 22 and Other Kernel Drivers and Modules 24.

Thus, application programs access computer files via the system call. In UNIX™, the system call for accessing a file abstracts the file into a contiguous storage space addressable with a handle and an offset. For example, in UNIX™, the following code snippet opens and reads a file named /path/filename:

Handle = open(“/path/filename”, O_RDWR);
Read_count = pread(handle, buffer_address, count, offset);

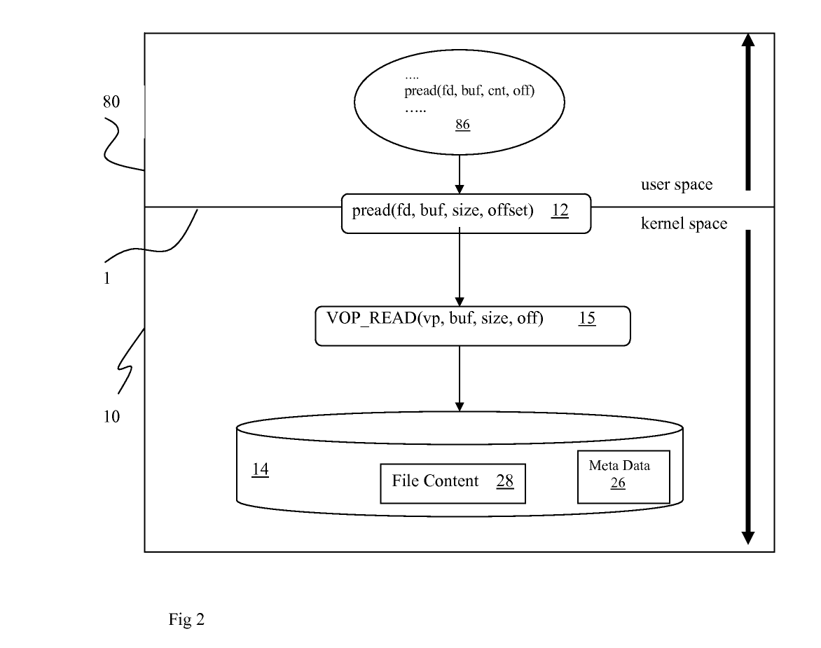

Correspondingly, FIG. 2 is the simplified flow chart of a file-accessing process that reads a file within the computer system, the pread system call. From the top, the application Program 86 makes the pread( ) system call as:

pread(fd, buf, cnt, off)

The pread( ) system call enters the System Call 12 of the Kernel Space 10 as:

pread(fd, buf, size, offset)

The System Call 12 then invokes the VOP_READ( ) 15 interface with the Virtual File System 14 as:

VOP_READ(vp, buf, size, off)

Finally, the Virtual File System 14 sends a corresponding read request to a selected member of the various existing file systems (NFS 16, UFS 17, Ext2fs 18, etc.) and obtains the file data as Meta Data 26 and File Content 28. Notice that, inter alia, the Meta Data 26 includes the legacy file attribute of the computer file.

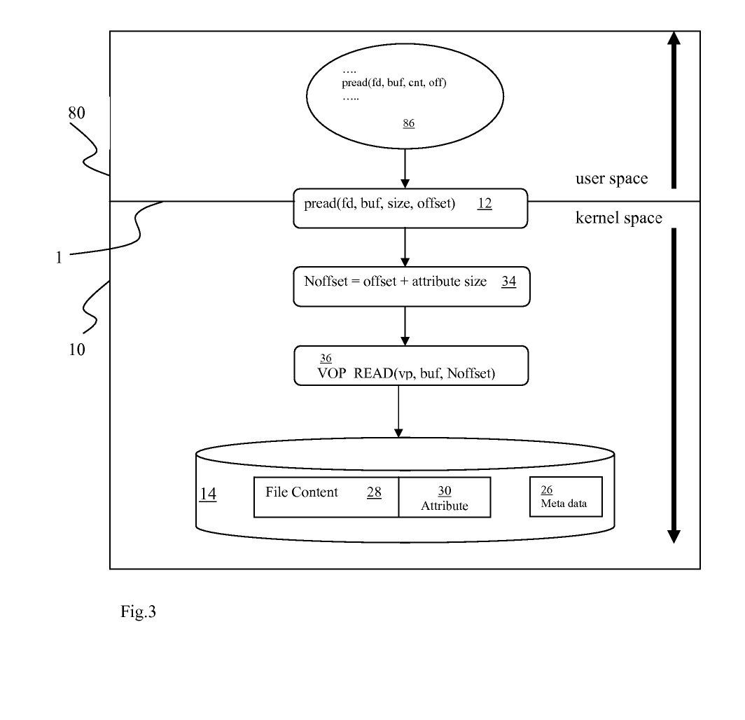

Notice that, after obtaining the file data, the Virtual File System 14 only maintains the accessed File Content 28 as a sequence of bits and bytes and the Virtual File System 14 does not interpret or process the File Content 28. Hence, to extend the existing FA into an EFA without modifying either the existing applications (82, 84, etc.) or the existing Virtual File System 14, the present invention proposes to modify the System Call 12 into a new one capable of handling the EFA in a way transparent to both the Virtual File System 14 and the existing API functions. More specifically, the present invention proposes to encode the EFA and concatenate the encoded EFA to thus forming a part of the File Content 28. FIG. 3 is a simplified illustration of a file-accessing process that employs the fundamental mechanism of the present invention to read a file with EFA. As illustrated, this invention adds additional EFA-related processing following the pread( ) System Call 12 to reserve additional space in the file content for storing EFA-related data that is not visible and not accessible by existing application programs via standard file access system calls. This additional space is reserved in Address Offset 34 by adjusting the parameter “offset”, an address offset during the file access process, to skip an area of “attribute size” for EFA storage. For example, the first 100 bytes of the file could be set aside for EFA storage that is at the same time invisible to the existing application programs. Thus, when an application program desires to read the real file content, the pread( ) system call would set “offset”=101 then calls the VFS Interface 36 thus insuring a correct reading of the real file content. On the other hand, when the System Call 12 desires to read the EFA, the pread( ) system call would set “offset”=0 then calls the VFS Interface 36 thus insuring a correct reading of the EFA, shown as Attribute 30 read by the Virtual File System 14. For those skilled in the art, by now it should become clear that all other file-access related system calls, such as pwrite( ) and stat( ), would need additional EFA-related processing similar to the just-described to correctly process the Attribute 30. Also, numerous variations of embodiment within the scope of the present invention can also achieve the same functionality. For example, an alternative embodiment can be:

When an application program desires to read the real file content, the pread( ) system call would set “offset”=0; whereas, when the System Call 12 desires to read the EFA, the pread( ) system call would set “offset”=the size of the file content, etc.

However, to facilitate discrimination between files created with the EFA and legacy files created absent the EFA thus reducing the probability of accessing a false EFA due to data coincidence, a variety of predefined encoding schemes can be incorporated into the above EFA storage for embedding the EFA content and some specific examples will be presently described. In essence, FIG. 3 illustrates a file attribute extension mechanism for adding desired EFA to a legacy FA. During creation of the EFA, the file attribute extension mechanism adds the EFA to the legacy FA by concatenating an encoded file content extension of a pre-defined extension file size, embedding the EFA, to the file content. During a later access of the EFA, the file attribute extension mechanism then accesses, decodes the encoded file content extension to access the decoded EFA. The mechanism through which the file attribute extension mechanism accesses the encoded file content extension is as follows:
1) An API function, invoked by an application program, generates a system call to access the file with the EFA.
2) The system call calls the legacy VFS thus accessing the file together with its legacy file attribute and the concatenated encoded file content extension.

By now it should become clear that the as-described present invention achieves the file attribute extension function without modifying the legacy VFS.

As remarked before, to distinguish between files created with the EFA and legacy files created absent the EFA thus reducing the probability of accessing a false EFA due to data coincidence, numerous predefined encoding schemes can be incorporated into the encoded file content extension. This can be very important, for example, during the process of converting legacy files into files with EFA wherein both types of files coexist and are under the management of the new OS. As an embodiment, the encoded file content extension can be restricted to only contain certain allowable EFA data patterns from a pre-defined validity set. Correspondingly, the decoding of the encoded file content extension by the file attribute extension mechanism further includes checking the accessed alleged EFA against the validity set thus either confirming its validity in the case of files created with EFA or denying its validity in the case of legacy files created without EFA. Of course, for simplicity, this validity set can be set to be all-inclusive, equivalent to accepting all variations of the EFA data pattern. As a second embodiment, the encoded file content extension can include a delineation of the embedded EFA with a pre-defined set of valid delineation data patterns. Correspondingly, the decoding of the encoded file content extension by the file attribute extension mechanism further includes checking for the existence of such valid delineation data patterns thus either confirming its validity in the case of files created with EFA or denying its validity in the case of legacy files created without EFA. As a refinement, the delineation data patterns can further include a pre-defined leading signature pattern preceding the EFA data and a pre-defined trailing signature pattern following the EFA data, for example a fixed leading signature pattern of eight (8) bytes plus a fixed trailing signature pattern of sixteen (16) bytes. Likewise, the EFA data itself can be restricted to a specifiable number of EFA data bytes, such as 256 bytes. Another refinement is to have the specifiable number itself following the leading signature pattern. Another important concept of the present invention is to make the invocation of the API mechanism syntactically identical to the invocation of a corresponding legacy API function of a legacy OS without the file attribute extension function. This makes the EFA functionality transparently available to all the existing application programs.

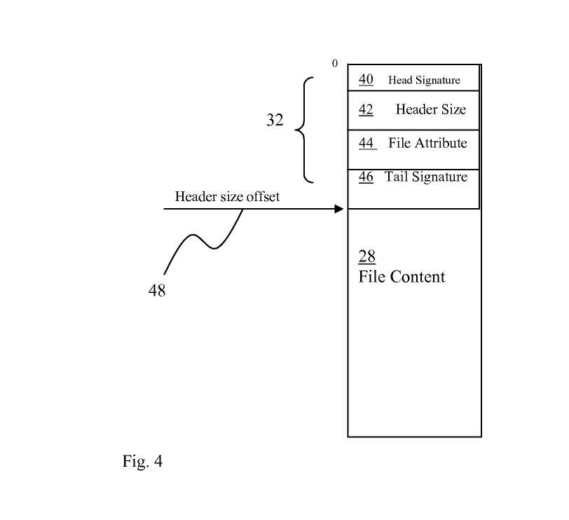

FIG. 4 is an example of a simplified data structure illustrating the concatenation of an encoded file content extension 32 to the File Content 28 under the present invention. The size of the encoded file content extension 32 defines a Header Size Offset 48 used to control the access of either the encoded file content extension 32 or the File Content 28. Within the encoded file content extension 32, the embedded File Attribute 44 itself is preceded by a Head Signature 40 and followed by a Tail Signature 46. Furthermore, the size of the encoded file content extension 32 is stored as a number called Header Size 42 placed between the Head Signature 40 and the File Attribute 44. As for example of implementation at the programming level, the following is a commented C program pseudo code defining the encoded file content extension 32 plus implementing the file attribute extension mechanism as was already illustrated at the flow chart level in FIG. 3:

/*
* To illustrate this invention, this pseudo code defines and implements a
* Sticky attribute in EFA. Other attributes can be added and
* processed in a like manner.
*/
/*
* This structure defines EFA structure
*/
struct EFA {

| | | |
|---|---|---|
| int | head_sig; | /* head signature */ |

| | | |
|---|---|---|
| int | header_size; | /* size of this structure */ |

| | | |
|---|---|---|
| int | version; | /* version of this EFA */ |
| int | file_attr_flags; | /* flags for file attributes */ |

| | | |
|---|---|---|
| #define | STICKY_FLAG | 0x0001 |
| #define | FORCE_ENCRYPT | 0x0002 |

| | | |
|---|---|---|
| char | reserved_buf[128]; | /* future expansion for file |

attributes */

| | | |
|---|---|---|
| int | tail_sig; | /* tail signature */ |

};

| | | |
|---|---|---|
| #define | HEAD_SIG | 0x5A5AF1F0 |
| #define | TAIL_SIG | 0xA5A51F0C |

// auxiliary boolean function to help determine if the file
// pointed by vp contains a EFA.
// Note that this function can be optimized by caching the status with the
vnode
int file_contains_EFA(struct vnode *vp, struct EFA *hp /* out */)
{

int nread;
struct EFA hbuf;
// see if the file contains a EFA struct
nread = VOP_READ(vp. &hbuf, sizeof(hbuf), 0L, SYS_SPACE);
// if file smaller then the EFA, then it can not contain a EFA
if (nread < sizeof(hbuf) {

return 0;

}
// ok, see if a valid EFA
if (hbuf.head_sig == HEAD_SIG && hbuf.tail_sig ==
TAIL_SIG
&& hbuf..header_size = sizeof(hbuf)) {

// Found the EFA
If (hp != NULL) {

| | |
|---|---|
| *hp = hbuf; | //return the EFA data |

}
return 1;

}
return 0;

}
// kernel pread system call
int pread(int fd, char *ubuf, size_t len, off_t offset)
{

Off_t Noffset = offset;
int nread;
struct vnode * vp = fd_to_vp(fd);
// convert file descriptor to vnode pointer
vp = fd_to_vp(fd);
if (file_contains_EFA(vp, NULL)) {

Noffset += sizeof(struct EFA);

}
return VOP_READ(vp, ubuf, len, Noffset, USER_SPACE);

}
// kernel pwrite system all
int pwrite(int fd, char *ubuf, size_t len, off_t offset)
{

off_t Noffset = offset;
struct vnode *vp;
vp = fd_to_vp(fd);
if (file_contains_EFA(vp, NULL)) {

Noffset += sizeof(struct EFA);

}
Return VOP_WRITE(vp, ubuf, len, Noffset, USER_SPACE);

}
// kernel unlink system call (used to remove a file)
int unlink(char *upath)
{

```
char *kpath = path_get(upath);
struct vnode *vp;
struct EFA hbuf;
vp = path_to_vp(kpath);
// if file contains EFA and sticky attribute, then do not
// allow unlink unless kernel is in single user mode.
if (file_contain_EFA(vp, &hbuf) &&
  (hbuf.file_attr_flags & STICKY_FLAG) &&
  !in_single_user_mode( )) {
```

| path_put(kpath); | |
|---|---|
| return EIO; | // return error |

}
path_put(kpath);
return VOP_UNLINK(vp);

}
// set_EFA system call
// This system call adds, or modify existing, EFA to a file referenced
by ‘path’
//
Int set_EFA(char *path, struct EFA *efa, int mask)
{

struct vnode *vp;
struct EFA hbuf;
if (path_to_vnode(path, &vp) != 0) {

return ENOENT;

}
If (file_contains_EFA(vp, &hbuf)) {

// update existing EFA
update_EFA(vp, efa, mask);

} else {

// add EFA to this file
add_EFA(vp, efa, mask);

}

}

As an auxiliary, nevertheless important ingredient at the practice level, the System Call 12 also includes a file attribute management mechanism, essentially an EFA management Interface, for managing the EFA of each file and, based upon the EFA data, for logically generating the corresponding call to the various legacy virtual file systems such as 13 and 14. Managing the EFA of each file is a utility function that involves its creation, viewing, modification, and removal by the file attribute management mechanism. An example of this utility function is already illustrated by utility programs via the newly created set_EFA( ) system call listed in the above pseudo code. During actual application of the EFA, the file attribute management mechanism then accesses the EFA and logically generates the corresponding call to the various legacy virtual file systems to achieve functions and features, to be presently illustrated with specific examples, intended by the thus accessed EFA. That is, numerous application friendly APIs can be created on top of the above set_EFA( ) system call. For example, the following pseudo code segment sets an AUDIT_ON flag in a subject EFA. The AUDIT_ON flag enables a history of audit logs to be generated whenever a file with the subject EFA is accessed, regardless of the success or failure of the access. The thus generated audit logs can later be accessed and viewed under a simple scheme of audit control. For those skilled in the art, more complex audit control schemes can be implemented using more flags.

int enable_audit(char *file)
{

struct EFA efa;
efa.flags = EFA_AUDIT_ON;
return set_EFA(file, &efa, EFA_FLAGS);

}

EFA can provide extra functionalities at the OS level thus useful for all application programs and all files. A first specific application example is called file encryption key delegation. Functionally, the key is equivalent to a password for accessing certain computer resources, such as certain password-protected files. Under the concept of key delegation, an encryption key can be created and stored within the EFA area of an executable program file with the file attribute management mechanism, the encryption key can further be kept in a scrambled format for privacy. As an example of implementation under the file attribute management mechanism, the OS execve( ) system call can be modified to detect such an encryption key in EFA of the program file hence making the key effective for the program process upon its launching. Thus, the encryption key is assigned to a program rather than a user in a traditional manner. Upon launching of the program, the key can be made effective also with the file attribute management mechanism as the runtime credential of the program authorizing it to access certain protected files which a user would not be able to access otherwise. Thus, for example, the user who runs the program is made unaware of the key and its management. This type of key isolation from the user can be desirable either for security or for convenience reason. An application example of is that a daemon program can be allowed to be started automatically by the OS without any user involvement. Another example is a database program maintaining and managing the user identification and authentication data base for the whole user community. While each user should not be allowed to access any other user's identification and authentication, upon launching the database program itself needs to be automatically delegated with encryption keys of the whole user community. A second specific application example of EFA is called forced file encryption. Under this scheme the attribute management mechanism stores a flag in the EFA area of a program file. When the flag gets set by the attribute management mechanism, all files created by the program file during its runtime are to be automatically encrypted under the logic dictation of the attribute management mechanism. As in many cases it is highly important to achieve an air-tight control and to remove any potential or accidental clear data leaks under an encryption scheme, the attribute management mechanism can be further equipped to logically force all child processes of the subject program to inherit its EFA with the same flag. Many UNIX™ programs create temporary files under the /tmp directory during their runtime. Hence, this feature of inheritance ensures that no information can leak even from these temporary files. As an example of implementation under the file attribute management mechanism, the OS open(2) and create(2) system calls can be modified to check the forced file encryption attribute of the running program and, if this attribute is set, automatically encrypt any newly created files during the file creation process.

A new computer OS has been described to extend the legacy file attribute of numerous legacy files accessed under the management of a legacy virtual file system. The new OS, besides supporting numerous application programs, has a file attribute extension mechanism for adding desired EFA to existing legacy file attribute. With respect to the above descriptions, it is to be realized that numerous variations and extensions of the embodiments are deemed readily apparent and obvious to one skilled in the art, and all equivalent relationships to those illustrated in the figures and described in the specification are intended to be encompassed by the present invention. For example, to those skilled in the art, by now it should become clear that the scope of the present invention is clearly applicable to numerous other OS such as, but not limited to, LINUX™, Windows™, Mac OS™, etc. Therefore, the foregoing is considered as illustrative only of the principles of the invention. Furthermore, since numerous modifications and changes will readily occur to those skilled in the art, it is not desired to limit the invention to the exact construction and operation shown and described and accordingly, all suitable modifications and equivalents may be resorted to fall within the scope of the invention.

What is claimed is:

1. A computer system with a file attribute extension function, the computer system comprising:
a) a file storage subsystem for storing numerous files each accessible through its pre-assigned file address and each file further includes a file content and a legacy file attribute of legacy attribute size (Mike: why we need legacy attribute size? Can we remove this item?);
b) a memory;
c) at least one processor, including programming, for executing instructions implementing an Operating System (OS) and at least one application program, said at least one processor being coupled to said file storage subsystem and said memory to permit data transfer there between, said OS further including:
c1) a legacy virtual file system for receiving a call from within said OS and effecting a corresponding read/write operation accessing said each file;
c2) a file attribute extension means for adding desired extended file attribute to said legacy file attribute, said file attribute extension means further including:
c21) during creation of said extended file attribute, adding said extended file attribute to said legacy file attribute by concatenating an encoded file content extension of a pre-defined extension file size, embedding said extended file attribute, to said file content; and
c22) during access of said extended file attribute, accessing, decoding said encoded file content extension and accessing the decoded extended file attribute;
c3) an Application Programming Interface (API) means, invokable by the execution of instructions of said at least one application program, for generating a system call to access said each file with said extended file attribute; and
c4) said system call for firstly calling said legacy virtual file system thus accessing said each file together with its legacy file attribute and said concatenated encoded file content extension, and secondly accessing the extended file attribute via said file attribute extension means
thereby achieving the file attribute extension function without modifying said legacy virtual file system.

2. The computer system of claim 1 wherein said system call further comprises a file attribute management means for managing the extended file attribute of each of said numerous files and, based upon said extended file attribute, for generating the corresponding call to said legacy virtual file system and for logically effecting functions corresponding to said extended file attribute.

3. The computer system of claim 1 wherein said encoded file content extension further comprises allowable extended file attribute from a pre-defined validity set and, correspondingly, said decoding of the encoded file content extension further comprises checking the accessed extended file attribute against said validity set to facilitate discrimination between files created with the file attribute extension function and legacy files created absent the file attribute extension function thereby reducing the probability of accessing a false extended file attribute.

4. The computer system of claim 1 wherein said encoded file content extension further comprises a delineation of the embedded extended file attribute with a pre-defined set of delineation data patterns and, correspondingly, said decoding of the encoded file content extension further comprises checking for valid delineation data patterns to facilitate discrimination between files created with the file attribute extension function and legacy files created absent the file attribute extension function thereby reducing the probability of accessing a false extended file attribute.

5. The computer system of claim 4 wherein said pre-defined set of delineation data patterns further comprises a pre-defined leading signature pattern preceding said extended file attribute and a pre-defined trailing signature pattern following said extended file attribute.

6. The computer system of claim 5 wherein said leading signature pattern further comprises a predefined number of leading signature bytes.

7. The computer system of claim 5 wherein said trailing signature pattern further comprises a predefined number of trailing signature bytes.

8. The computer system of claim 5 wherein said extended file attribute further comprises a specifiable number of extended file attribute bytes.

9. The computer system of claim 8 wherein said pre-defined set of delineation data patterns further comprises said specifiable number following said leading signature pattern.

10. The computer system of claim 4 wherein said embedded extended file attribute further comprises allowable extended file attribute from a pre-defined validity set and, correspondingly, said decoding of the encoded file content extension further comprises checking the accessed extended file attribute against said validity set to facilitate discrimination between files created with the file attribute extension function and legacy files created absent the file attribute extension function thereby reducing the probability of accessing a false extended file attribute.

11. The computer system of claim 1 wherein the invocation of said API means is made syntactically identical to the invocation of a corresponding legacy API function of a legacy operating system without the file attribute extension function thereby facilitating a backward compatibility with said legacy operating system at the application programming level.

12. The computer system of claim 1 wherein said legacy virtual file system further comprises accessing said each file under a plurality of selectable existing file systems FSᵢ with i=(1, 2, . . . , M) and M>=1 thereby achieving the file attribute extension function without modifying said existing file systems FSᵢ.

13. The computer system of claim 12 wherein said existing file systems FSᵢ further includes AFS (Andrew FS), NFS, UFS, EXT2, EXT2FS, EXT3, REISER, JFS, JFS2, NTFS, MSDOS-FS, ISOFS, CDROMFS, CACHEFS, NAMEFS, HPFS, CODAFS, ADFS and SMBFS.

14. The computer system of claim 1 wherein the extended file attribute of said numerous files further includes file annotation, file language, file encryption, file encryption inheritance, file encryption key delegation, file mobility and user-accessibility of said file content.

15. A method for extending the file attribute of numerous files stored within a file storage subsystem of a computer system having at least one processor for executing instructions implementing an Operating System (OS) and at least one application program, wherein the OS further includes a legacy virtual file system layer for receiving a call from within the OS and effecting a corresponding read/write operation accessing each of the numerous files and each file further includes a file content and a legacy file attribute, the method comprising:
a1) creating a desired extended file attribute and adding said extended file attribute to said legacy file attribute by encoding and concatenating an encoded file content extension of a pre-defined extension file size, embedding said extended file attribute, to said file content;
a2) providing an Application Programming Interface (API), invokable by the execution of instructions of said at least one application program, for generating a system call to access said each file with said extended file attribute; and
a3) with said system call, firstly calling said legacy virtual file system and accessing said each file together with its legacy file attribute and said concatenated encoded file content extension, and secondly decoding the accessed encoded file content extension to access the desired extended file attribute
thereby extending the file attribute without modifying said legacy virtual file system.

16. The method of claim 15 further comprises, with said system call, managing the extended file attribute of said each file and, based upon said extended file attribute, generating the corresponding call to said legacy virtual file system.

17. The method of claim 15 wherein encoding the encoded file content extension further comprises restricting allowable extended file attribute to a pre-defined validity set and, correspondingly, decoding the accessed encoded file content extension further comprises checking the accessed extended file attribute against said validity set to facilitate discrimination between files created with the desired extended file attribute and legacy files created absent the desired extended file attribute thereby reducing the probability of accessing a false extended file attribute.

18. The method of claim 15 wherein encoding the encoded file content extension further comprises delineating the embedded extended file attribute with a pre-defined set of delineation data patterns and, correspondingly, decoding the accessed encoded file content extension further comprises checking for valid delineation data patterns to facilitate discrimination between files created with the desired extended file attribute and legacy files created absent the desired extended file attribute thereby reducing the probability of accessing a false extended file attribute.

19. The method of claim 18 wherein said pre-defined set of delineation data patterns further comprises a pre-defined leading signature pattern preceding said extended file attribute and a pre-defined trailing signature pattern following said extended file attribute.

20. The method of claim 19 wherein said leading signature pattern further comprises a predefined number of leading signature bytes.

21. The method of claim 19 wherein said trailing signature pattern further comprises a predefined number of trailing signature bytes.

22. The method of claim 19 wherein said extended file attribute further comprises a specifiable number of extended file attribute bytes.

23. The method of claim 22 wherein said pre-defined set of delineation data patterns further comprises said specifiable number following said leading signature pattern.

24. The method of claim 18 wherein encoding the encoded file content extension further comprises restricting allowable embedded extended file attribute to a pre-defined validity set and, correspondingly, decoding the accessed encoded file content extension further comprises checking the accessed extended file attribute against said validity set to facilitate discrimination between files created with the desired extended file attribute and legacy files created absent the desired extended file attribute thereby reducing the probability of accessing a false extended file attribute.

25. The method of claim 15 wherein providing the API further comprises making the invocation of the API syntactically identical to the invocation of a corresponding legacy API function of a legacy operating system without the extended file attribute thereby facilitating a backward compatibility with said legacy operating system at the application programming level.

26. The method of claim 15 wherein said legacy virtual file system further comprises accessing said each file under a plurality of selectable existing file systems FSᵢ with i=(1, 2, . . . , M) and M>=1 thereby extending the file attribute without modifying said existing file systems FSᵢ.
